(19) United States
(12) Patent Application Publication
(10) Pub. No.: US 2025/0119446 A1
(43) Pub. Date: Apr. 10, 2025

(54) ARTIFICIAL INTELLIGENCE BASED CYBERSECURITY SYSTEM FOR MONITORING AUTOMOTIVE ECOSYSTEMS

(71) Applicant: Darktrace Holdings limited, Cambridge (GB)

(72) Inventors: Samuel Goldsmith, Norfolk (GB); Jack Pearson, Nurthumberland (GB); Simon Fellows, Peterborough (GB); David Evans, Cambridge (GB)

(21) Appl. No.: 18/908,203

(22) Filed: Oct. 7, 2024

Related U.S. Application Data
(60) Provisional application No. 63/542,708, filed on Oct. 5, 2023.

(51) Int. Cl. H04L 9/40; H04W 4/46; H04W 12/00

(52) U.S. Cl. CPC H04L 63/1425; H04W 4/46; H04W 12/009

(57) ABSTRACT

A cyber threat defense system is provided comprising: a processing component; and a non-transitory computer readable medium including one or more software modules accessible by the processing component, the one or more software modules comprising: a vehicle module configured to receive data from a first vehicle and a second vehicle and reference one or more machine-learning models using machine-learning and artificial intelligence (AI) algorithms, the one or more machine-learning models including a first machine-learning model trained on a normal pattern of life associated with the first vehicle and the second vehicle, and a comparator module configured to cooperate with the vehicle module to compare data received from the first vehicle and the second vehicle to the normal pattern of life associated with the first vehicle and the second vehicle to detect anomalies representing a cyber threat within the first vehicle or the second vehicle. A corresponding method and non-transitory computer readable medium are also provided.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### RELATED APPLICATION

This application claims priority under 35 USC 119 to U.S. provisional patent application No. 63/542,708, titled “CLOUD-BASED CYBER SECURITY AND METHODS OF OPERATION” filed Oct. 5, 2023, which the disclosure of such is incorporated herein by reference in its entirety.

### FIELD

Embodiments of the design provided herein generally relate to an artificial intelligence based cybersecurity system for monitoring automotive ecosystems.

### BACKGROUND

Vehicles, particularly land based vehicles such as automobiles, motorbikes, trucks and the like, but also including other land based vehicles such as trains and trams, water based vehicles such as ships, boats, and submersibles, amphibious vehicles such as hovercraft, and aerial vehicles such as planes and helicopters are increasingly becoming more connected. Such vehicles may connect to other vehicles in their environment (so called vehicle-to-vehicle or V2V) and infrastructure (vehicle-to-infrastructure or V2I), for example. More generally, vehicles may connect to any relevant device or entity, referred to vehicle-to-everything or V2X. This is increasingly done via the internet over wireless communication means, such as fifth generation cellular technology (5G), though other forms of wired or wireless communication can also be used. As well as connecting to entities relevant for the movement of the vehicle, vehicles are also increasingly connected to provide multimedia content and the like.

Due to the rise in connected vehicles, devices and systems, the “digital estate” under the control, management or responsibility of an enterprise (such as a vehicle manufacturer) has grown rapidly and created security blind-spots and artificial segregation of network visibility. Where previously it was sufficient to cover logical zones with cyber threat defense measures such as an office network, an email environment, and a production environment, enterprise networks increasingly contain additional independent systems like IoT devices or internet-connected smart systems such as vehicles or manufacturing equipment. These independent systems have uncommon protocol and data types for a traditional cyber protection system to analyze. Commercial cyber threat defense systems are restricted to logical enterprise zones by the specialization and focus of their machine learning approach, which is not versatile enough to accommodate unseen data types and structures without significant development work. The lower level protocols in a protocol stack also have widely varying data types that are different than those typically analyzed by most commercial third party cyber security protection systems; thus, making them unusual protocols to be analyzed by a traditional cyber protection system.

### SUMMARY

In an embodiment, a cyber threat defense system can have one or more modules that utilize data received from a first vehicle and a second vehicle and compare the received data to a normal pattern of life associated with the first vehicle and the second vehicle to detect anomalies representing a cyber threat.

A vehicle module may be configured to receive data from a first vehicle and a second vehicle and reference one or more machine-learning models using machine-learning and artificial intelligence (AI) algorithms. The one or more machine-learning models may include a first machine-learning model trained on a normal pattern of life associated with the first vehicle and the second vehicle.

A comparator module may cooperate with the vehicle module to compare data received from the first vehicle and the second vehicle to the normal pattern of life associated with the first vehicle and the second vehicle to detect anomalies representing a cyber threat within the first vehicle or the second vehicle.

A vehicle normal pattern of life module may be configured to update the first machine-learning model using unsupervised machine learning algorithms and feedback to routinely update the first machine-learning model of the normal pattern of life of the first vehicle and the second vehicle during operation of the first vehicle and the second vehicle.

The cyber threat defense system may comprise the first probe and the second probe, the first and second probes configured to provide data to the vehicle module over a network.

An autonomous response module may be configured to determine an autonomous response to counter a detected cyber threat in the first vehicle or the second vehicle without human intervention

An AI analyst module may be configured to analyze the anomalies detected by the comparator module to identify and/or classify anomalies as cyber threats utilizing a second machine-learning model trained on data comprising previous or simulated cyber threats.

An operational technology module may be configured to receive data on an operational technology network from one or more sources and reference one or more machine-learning models using machine-learning and artificial intelligence (AI) algorithms, the one or more machine-learning models including a third machine-learning model trained on a normal pattern of life associated with a first entity and a fourth machine-learning model trained on a normal pattern of life associated with a second entity. The comparator module may further be configured to cooperate with the operational technology module to compare data received from the operational technology network to at least the normal pattern of life associated with the first entity or the normal pattern of life associated with the second entity to detect anomalies representing a cyber threat in the operational technology network

An enterprise module may be configured to receive data on an enterprise network from one or more sources and reference one or more machine-learning models using machine-learning and artificial intelligence (AI) algorithms, the one or more machine-learning models including a fifth machine-learning model trained on a normal pattern of life associated with a third entity. The comparator module may further be configured to cooperate with the enterprise module to compare data received from the enterprise network to at least the normal pattern of life associated with the third entity to detect anomalies representing a cyber threat in the enterprise network.

These and other features of the design provided herein can be better understood with reference to the drawings, description, and claims, all of which form the disclosure of this patent application.

### BRIEF DESCRIPTION OF THE DRAWINGS

The multiple drawings refer to the embodiments of the invention.

FIG. 1 illustrates a block diagram of an embodiment of a cyber threat defense system with various modules that reference machine-learning models that are trained on the normal pattern of life of entities to detect a cyber threat.

FIG. 2 illustrates a block diagram of an embodiment of an example chain of unusual behavior for the vehicle network under analysis.

FIG. 3 illustrates a block diagram of an embodiment of a cyber threat defense systems monitoring an example vehicle network.

FIG. 4 illustrates a block diagram of an embodiment of an example central cyber threat defense system with its modules and machine-learning models using probes to monitor the vehicle network, an enterprise network and an OT network.

FIG. 5 illustrates a block diagram of the cyber threat defense system in more detail in the context of providing vehicle, enterprise (office), and OT (factory) protection.

FIG. 6 illustrates an example cyber threat defense system, including the cyber threat defense system and its extensions, protecting an example network.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, number of servers in a system, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first server, can be made. However, the specific numeric reference should not be interpreted as a literal sequential order but rather interpreted that the first server is different than a second server. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

Herein, the term vehicle will be understood to encompass all manned and unmanned vehicles, including but not limited to automobiles or cars, motorcycles, mopeds, motor-tricycles, trucks, pickups, airplanes, helicopters, drones, unmanned arial vehicles (UAVs), ships, boats, submarines, trains, trams, monorails, hovercraft, and the like. The present disclosure has particular application as a cyber threat defense system covering vehicle networks comprising road vehicles, such as automobiles, motorcycles, trucks, and so on.

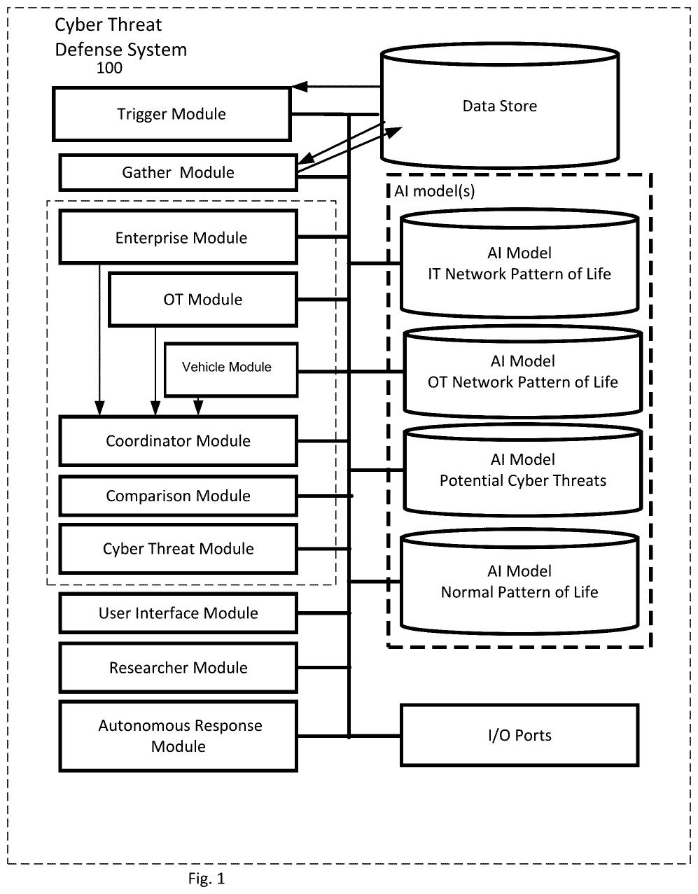

FIG. 1 illustrates a block diagram of an embodiment of a cyber threat defense system 100 with various modules that reference machine-learning models that are trained on the normal pattern of life of entities to detect a cyber threat. The cyber threat defense system may protect against cyber security threats to vehicles protected by the cyber threat defense system as well as potentially to an operational technology (OT) and to an enterprise network.

The cyber threat defense system 100 may include components such as i) a trigger module, ii) a gather module, iii) a data store, iv) a GUI module, v) a vehicle module, vi) an OT module, vii) an enterprise module, viii) a normal pattern of life module, ix) a coordinator module, x) a comparison module, xi) an AI analyst/cyber threat module, xii) a researcher module, xiii) an autonomous response module, xiv) at least one input or output (I/O) port to securely connect to other network ports as required, xv) one or more machine-learning models such as a first AI model trained one or more aspects of a vehicle network, a second AI model trained on aspects of cyber threats, third and fourth AI models trained on one or more aspects of an OT network, a fifth AI model trained on one or more aspects of an enterprise network, and additional AI models, each trained on different users, devices, system activities and interactions between entities in the system, and other aspects of the system, as well as xvi) other similar components in the cyber threat defense system 100. The one or more modules may be situated within the network to passively ingest entity traffic or utilize probes to interact with entities in the vehicle network and the OT and enterprise technology networks.

A trigger module may detect time stamped data indicating one or more i) events and/or ii) alerts from I) unusual or II) suspicious behavior/activity are occurring and then triggers that something unusual is happening. Accordingly, the gather module is triggered by specific events and/or alerts of anomalies such as i) an abnormal behavior, ii) a suspicious activity, and iii) any combination of both. The inline data may be gathered on the deployment from a data store when the traffic is observed. The scope and wide variation of data available in the data store results in good quality data for analysis. The collected data is passed to the various modules as well as to the data store.

The gather module may comprise of multiple automatic data gatherers that each look at different aspects of the data depending on the particular hypothesis formed for the analyzed event and/or alert. The data relevant to each type of possible hypothesis will be automatically pulled from additional external and internal sources. Some data is pulled or retrieved by the gather module for each possible hypothesis from the data store. A feedback loop of cooperation occurs between the gather module, the vehicle module monitoring vehicle network activity, the OT module monitoring OT activity, the enterprise module monitoring enterprise network activity, the comparison module to apply one or more models trained on different aspects of this process, and the cyber threat/AI analyst module to identify cyber threats based on comparisons by the comparison module. Each hypothesis of typical cyber threats can have various supporting points of data and other metrics associated with that possible threat, such as a human user insider attack, inappropriate network behavior, inappropriate behavior in a vehicle, inappropriate behavior in the OT network, inappropriate cloud behavior, etc. from a human user. The hypothesis of typical cyber threats to be supported or refuted also includes a malicious software or malware attack that causes inappropriate enterprise, inappropriate vehicle behavior, inappropriate OT behavior, etc. A machine-learning algorithm will look at the relevant points of data to support or refute that particular hypothesis of what the suspicious activity or abnormal behavior related for each hypothesis on what the suspicious activity or abnormal behavior relates to.

Networks have a wealth of data and metrics that may be collected. The gatherer modules may then filter or condense the mass of data down into the important or salient features of data. In an embodiment, the vehicle module, the enterprise module, the OT module, comparison module, the coordinator module, the cyber threat module can be combined or kept as separate modules.

The vehicle module can receive data from a vehicle network. The vehicle module can receive data from the vehicle network from i) one or more probes installed in components of a vehicle, ii) by passive traffic ingestion through a location within a vehicle (e.g., a central electronic control unit (ECU)), iii) one or more other servers connected to the vehicle network, and iv) any combination of these. The vehicle module can reference one or more machine-learning models using machine-learning and AI algorithms that are trained on a normal pattern of life of the vehicle network, and in particular a normal pattern of life of vehicles within the vehicle network. The normal pattern of life of the vehicles may be adapted to future updates of the vehicles. The behavior of the vehicles initially may change after a period of time, such as one or more years, for example, following one or more software updates.

The OT module can receive data on an operational technology network from i) a set of probes, ii) by passive traffic ingestion through a location within the network, and iii) any combination of both, whether located within the cyber threat defense appliance or located on the wider network. The OT module can reference various machine-learning models. The OT module can reference one or more machine-learning models, using machine-learning and AI algorithms, that are trained on a normal pattern of life of users of the OT network. The OT module can also reference one or more machine-learning models, using machine-learning and AI algorithms, that are trained on a normal pattern of life of devices in the OT network. The OT module can also reference one or more machine-learning models, using machine-learning and AI algorithms, that are trained on a normal pattern of life of OT environment specific entities such as Programmable Logic Controllers, Human Machine Interfaces, and the detailed process control communications between them.

The enterprise module can monitor data from an enterprise or business network. The enterprise module can receive data on an enterprise network from a set of probes or by centrally monitoring network traffic. The enterprise module can reference one or more machine-learning models that are trained on a normal behavior of at least one or more entities associated with the enterprise network; and thus, allow a comparator module to indicate when a behavior of the given entity falls outside of being a normal pattern of life.

A comparator module can compare the received data on one or more of the vehicle network, the OT network and the enterprise network to the normal pattern of life of any of the users, devices, entities, vehicles and controllers to detect anomalies in the normal pattern of life for these entities in order to detect a cyber threat.

Note, once the normal pattern of life has been learned by the models, then the comparator module can readily identify the anomalies in the normal pattern of life; and thus, unusual behaviors from the devices, users, entities, vehicles or controllers of any of the vehicle network, the OT network, and the enterprise network.

The vehicle network may be a network within a vehicle comprising the different electronic components, processors, devices and software within a vehicle, both for driving of the vehicle and peripheral, such as infotainment systems. The vehicle network may also be a network of multiple vehicles each in communication with the vehicle module, and the vehicle network may comprise networks within each of these multiple vehicles.

The OT environment is not restricted to OT-specific devices and protocols and vice versa. Commonly, enterprise devices and services are located with OT environments for purposes such as cross-compatibility, specific control procedures or other. Equally, traditionally OT hardware may be located within an enterprise network such as scientific equipment or specialized analysis devices. Devices may also move between OT and enterprise based upon their implementation purposes, such as an enterprise server running OT software or coordinating OT protocols. It is important to note that the OT module and enterprise module are not restricted to specific networks, the OT module may still analyze the pattern of life for the OT device located in a computer lab within the enterprise network. Similarly, the OT and enterprise modules are not restricted by device type. The enterprise module may therefore monitor the pattern of life for that OT device within the aforementioned computer lab as it pertains to the enterprise network. This is achieved through a coordinator module operating between the OT module and enterprise module.

A coordinator module can analyze and integrate both activities occurring in the OT network as well as activities occurring in the enterprise network at the same time when analyzing the detected anomalies in the normal pattern of life in order to detect the cyber threat.

A GUI can display metrics, alerts, and events of all of the vehicle network, the OT network, and the enterprise network in a coordinated and logical manner on a common display screen. The GUI allows a viewer to visually contextualize the metrics, alerts, and/or events occurring in each the vehicle network, the OT network and the enterprise network in light of the activities occurring in the other networks on the common display screen,

The GUI also allows a viewer to then to confirm the detected cyber threat in view of what is happening in each of the vehicle network, the OT network, as well as in the enterprise network. Visibility over the OT network in this manner can be advantageous even when a cyber threat is not detected, as malfunctions or misconfigurations in the production process can be viewed in the same manner.

A cyber threat module can compare a chain of one or more of the detected anomalies by referencing one or more machine-learning models trained on, at least, the cyber threat. Multiple machine-learning models may be trained, each model trained on a category of cyber threats and its corresponding members or each model trained on its own specific cyber threat. The cyber threat module cooperates and communicates with the other modules. Likewise, the vehicle module, the OT module, as well as the enterprise module each cooperate and communicates with the other modules.

The cyber threat defense system 100 may supplement the data provided to the users and cyber professionals using a researcher module. The researcher module can use one or more AI algorithms to assess whether the anomalous network activity has previously appeared in other published threat research or known lists of malicious files or Internet addresses. The researcher module can consult internal threat databases or external public sources of threat data. The researcher module can collect an outside data set describing at least one of an action or a state related to the cyber threat present outside of the network from at least one data source outside the network.

The cyber threat defense system 100 can then take actions in response to counter detected potential cyber threats. The autonomous response module, rather than a human taking an action, can be configured to cause one or more rapid autonomous actions in response to be taken to counter the cyber threat.

A user interface for the response module can program the autonomous response module i) to merely make a suggested response to take to counter the cyber threat that will be presented a display screen and/or sent by a notice to an administrator for explicit authorization when the cyber threat is detected or ii) to autonomously take a response to counter the cyber threat without a need for a human to approve the response when the cyber threat is detected. The autonomous response module will then send a notice of the autonomous response as well as display the autonomous response taken on the display screen.

The cyber threat module can cooperate with the autonomous response module to cause one or more autonomous actions in response to be taken to counter the cyber threat, improves computing devices in the system by limiting an impact of the cyber threat from consuming unauthorized CPU cycles, memory space, and power consumption in the computing devices via responding to the cyber threat without waiting for some human intervention.

With regards to the vehicle network, however, and countering a cyber threat detected within the vehicle network, autonomous responses must be much more carefully and restrictively deployed, as many systems within a vehicle will be crucial to the safety of that vehicle and the passengers or cargo within while the vehicle is in motion as well as other road users and pedestrians, and so only limited autonomous actions can be taken to isolate or shut down such systems, or to get the vehicle into a safe state. The potential immediate harm to the vehicle, passengers or cargo and other road users and pedestrians arising from taking an autonomous action must be carefully weighed against the usually longer term harm that may be caused by the cyber threat. There may also be cyber threats to counter while a vehicle is stationary. For example, malicious actors may act through electric vehicle (EV) charging stations at which EVs charge, for example to cause thermal runaway of their battery.

One factor that may be considered by the autonomous response module is whether a system or component compromised by a detected cyber threat is a primary system related to the control of the motion of the vehicle, such as a power train ECU, or a peripheral system, such as an in-car entertainment system or infotainment system. As explained above, an autonomous response may be taken to isolate or to shutdown such systems, or to get the compromised vehicle into a safe state. Peripheral systems may be much more readily acted upon by the autonomous response module. For example, an in-car entertainment system, which may be a common attack vector due to its ability to communicate with third-party servers and content distribution networks (CDNs) on the internet to obtain media content, may be disabled and quarantined by the autonomous response module without presenting direct safety risks to the vehicle, passengers, or cargo and other road users and pedestrians. However, there may not always be a clear divide between primary and peripheral systems, which may limit the autonomous actions available. When a vehicle is not moving, i.e., in a parked state, there is more freedom for performing autonomous actions without compromising the safety of the vehicle, or any passengers or cargo. For example, a compromised vehicle may be prevented from starting if it is currently parked. This may, however, be inconvenient or impractical for the owner of the vehicle.

In general, the autonomous response module may take a tiered approach. For low-risk cyber threats that do not present an immediate danger to the vehicle, passengers or cargo or other road users and pedestrians, a warning or alert may be presented to a user, driver, or owner of the vehicle, such as on an in-vehicle display or dashboard or through an associated mobile application. This warning may instruct the user, driver or owner to take the vehicle for servicing, and may, for example, present a code indicating the type of cyber threat or component compromised. For more serious cyber threats, the autonomous response module may restrict or disable peripheral systems in addition to presenting a warning, as above. For high-risk cyber threats, functionality of primary systems may be restricted, such as limiting a speed of the vehicle, and for extremely high-risk cyber threats that present an immediate threat to the safety of the vehicle, passengers, cargo, or other road users and pedestrians, the autonomous response module may bring the vehicle to a controlled stop.

The cyber threat defense system 100 may be hosted on a computing device, on one or more servers, or in its own cyber threat appliance platform.

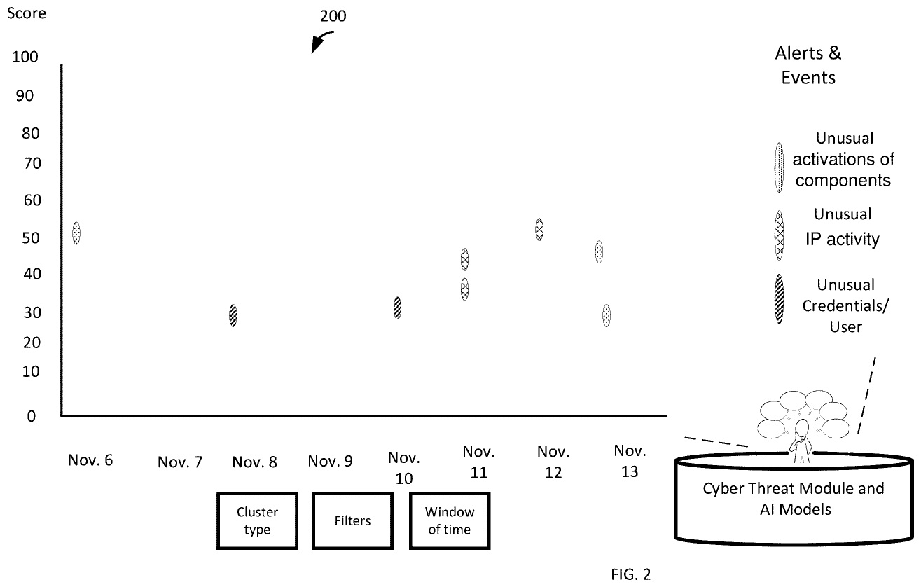

FIG. 2 illustrates a block diagram of an embodiment of an example chain of unusual behavior for the vehicle network under analysis. The user interface can display a graph 200 of an example chain of unusual behavior for a vehicle component in connection with the rest of the vehicle network under analysis.

The cyber threat module cooperates with one or more machine-learning models. The one or more machine-learning models are trained and otherwise configured with mathematical algorithms to infer, for the cyber threat analysis, ‘what is possibly happening with the chain of distinct alerts and/or events, which came from the unusual pattern of behaviors,’ and then assign a threat risk parameter associated with that distinct item of the chain of alerts and/or events forming the unusual pattern.

This is ‘a behavioral pattern analysis’ of what are the unusual behaviors of the entity under analysis by the various modules and the machine-learning models. The modules of the cyber threat defense system 100 determine unusual behavior deviating from the normal behavior and then build a chain of unusual behavior and the causal links between the chain of unusual behavior to detect potential cyber threats.

The one or more machine-learning models learn the similarities of behavior in groups of people and devices and can recognize that a person or device is no longer behaving like the group it is perceived to be a member of. In particular, a vehicle network will typically comprise a number of similar vehicles, be they different models from the same manufacturer, the same model from the same manufacturer, or similar models from different manufacturers (e.g., sharing components or control systems). By utilizing data from many different vehicles related in one or more of these ways, the machine-learning model can make use of a greatly increased pool of data to model a normal pattern of life.

An example behavioral pattern analysis of what are the unusual behaviors may be as follows. The unusual pattern may be determined by filtering out what activities, events, alerts, etc. that fall within the window of what is the normal pattern of life for that entity under analysis. Once the normal pattern of life has been learned, then the system is capable of identifying unexpected or unusual behaviors from devices or operators of devices. The pattern of the deviant behavior of the activities, events, alerts, etc. that are left, after the filtering, can be analyzed to determine whether that pattern is indicative of a behavior of a malicious actor, such as a human, a program, an email, errant programming or configuring of a component, or other threat. The cyber threat defense system 100 can go back and pull in some of the filtered out normal activities to help support or refute a possible hypothesis of whether that pattern is indicative of a behavior of a malicious actor. An example behavioral pattern included in the chain is shown in the graph over a time frame of, an example, 7 days. The cyber threat defense system 100 detects a chain of anomalous behavior of unusual activations of components three times, unusual characteristics occur 3 times in Transmission Control Protocol/Internet Protocol (TCP/IP) activity in the gateway feeding each of the components being activated; and thus, seem to have some causal link to the unusual activations. Likewise, twice unusual credentials have a causal link to at least one of those three activations. When the behavioral pattern analysis of any individual behavior or of the chain as a group is believed to be indicative of a malicious threat, then a score of how confident the cyber threat defense system 100 is in this assessment of identifying whether the pattern was unusual given the contextual factors and pattern of life analysis is created.

An additional point to note is that the vehicle module, the OT module and the enterprise module reference their respective machine-learning models perform filtering to isolate what is unusual for the highest level of analysis. This means a large amount of data can be excluded at every level which greatly reduces the amount of calculations needed on a continuous basis. This also speeds up the analysis to allow near real time analysis of unusual behaviors occurring and being able to rapidly determine if those unusual behaviors actually correlate to a potential cyber threat.

Next, also the cyber threat module can assign a threat level parameter (e.g. score or probability) indicative of what level of threat does this malicious actor pose to the system. These can be combined/factored into a single score. The score may be an actual score, a percentage, a confidence value, or other indicator on a scale. As discussed, the cyber threat defense system 100 is configurable in its user interface of the cyber threat defense system 100 on what type of automatic response actions, if any, the cyber threat defense system 100 may take when for different types of cyber threats that are equal to or above a configurable level of threat (threat level parameter) posed by a detected malicious actor/cyber threat.

The vehicle module, the OT module, and the enterprise module reference their respective machine-learning models are capable of learning what ‘normal’ activity looks like within an example vehicle network, industrial network, and enterprise network respectively in conjunction with the cyber threat module, and can identify and respond to emerging threats and potential malfunctions that would otherwise go unnoticed. ‘Normal’ activity may change over time, for example over a period of one or two years, such as caused by software updates to the vehicle.

The cyber threat module, vehicle module, enterprise module, and an OT module are built on a foundation of machine-learning and AI algorithms, and cooperate to analyze complex network environments to detect indicators of threats against the ‘pattern of life’ that characterizes each network, device, and user. By identifying unexpected anomalies in behavior, the cyber defense appliance autonomously defends against all threat types from advanced malware to insider threat and IoT hacks, as they emerge, at the earliest stage of the attack life cycle.

The cyber threat module referencing the one or more machine-learning models trained on potential cyber threats recognizes associated chains of behaviors, for example: an attack begins when a passenger in a vehicle requests an in-car entertainment system to obtain content from a compromised CDN. The compromised CDN delivers malware that spreads through a network within a vehicle compromising a motor control unit of the vehicle with the potential for significant future harm. All stages of this attack can be identified by the vehicle module and the cyber threat module referencing their respective machine-learning models and presented together in context to a security professional.

In another example, an attack begins by subverting a public relations officer's laptop in a corporate environment, the attack spreads to computer systems in the procurement division, the procurement division is able to access stock/supply information in the operational environment and the attack spreads into this industrial arena. The attack begins to manipulate the industrial environment with the potential for future harm. All stages of this attack can be identified by the OT module, cyber threat module, and enterprise module referencing their respective machine-learning models and presented together in context to a security professional.

The cyber threat module can present its summarized findings on the GUI to enable further human investigation into the detailed attack/unusual behavior.

The cyber threat module can use the machine-learning models to flag activities that indicate a compromise or ongoing threat when they represent a significant departure from the normal behavior.

The cyber threat module can highlight unusual use of access rights, such as the unusual reprogramming of control system devices by an administrator. The cyber threat module provides visibility of weak or compromised authentication in use, as well as attacks on authentication systems. The cyber threat module can highlight system reconnaissance, particularly of control systems, from external or compromised internal devices which may be indicative of the beginning of a malware attack. The cyber threat module highlights activity of new and unknown malware within the network. The cyber threat module can help identify misconfigurations that affect resilience, and highlight attacks on key administrative interfaces. The cyber threat module can highlight unusual connectivity or data transfer within the vehicle network, the OT network, the enterprise network, between the OT or vehicle networks and the enterprise network and between the OT or vehicle network and third-party locations such as the internet or networks administrated by suppliers or third-party vendors or content providers.

The cyber threat module communicating the autonomous response module can be programmed to prevent this unauthorized access to data whether through unauthorized access to user devices, interception of data in transit, or by other means. The modules can maintain confirmation of the use of encryption where it is wanted, and highlight unusually weak or missing encryption.

Creating powerful ‘pattern of life’ models of every individual and device on your network allows the cyber threat module to detect even subtle shifts in behaviors, such as the way someone is using technology, a machine's data access patterns or trends in communications. This may indicate any number of potentially threatening events, such as the theft of a user's credentials, a compromised device, or the actions of a disaffected or negligent employee.

Note, the unusual behavior might be a result of misconfiguration, accidental use, malicious use by a legitimate operator, or malicious use by a third party. The cyber threat immune system has no prior assumptions and is capable of learning about the behavior of any vehicle, device or person in various environments. The cyber threat immune system uses many different machine-learning/AI techniques that compete to learn the best possible pattern of life for individual vehicles, devices, and people or subsets of their behavior. As noted above, having a large number of individual vehicles all of a same or similar category, such as the same make or same model, can give the machine-learning/AI models large amounts of data to learn the best possible patterns of life.

Note, the one or more models trained on the ‘pattern of life’ can use a subset of machine-learning algorithms. Also, these machine-learning models can use self-learning algorithms and mathematics to start working from day one, detecting anomalous behaviors across the organization. The machine-learning models using the self-learning algorithms continue to learn on an ongoing basis—constantly updating as the networks being protected evolve. Thus, the cyber threat defense system 100, as a self-learning technology, is extremely quick to deploy, and does not require a long roll-out project or manual intervention to maintain.

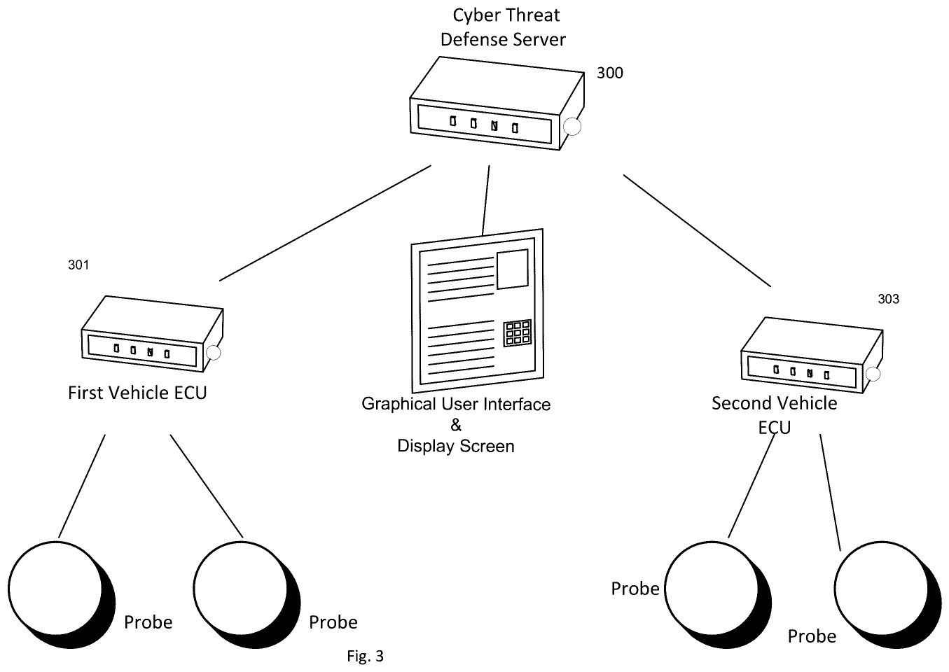

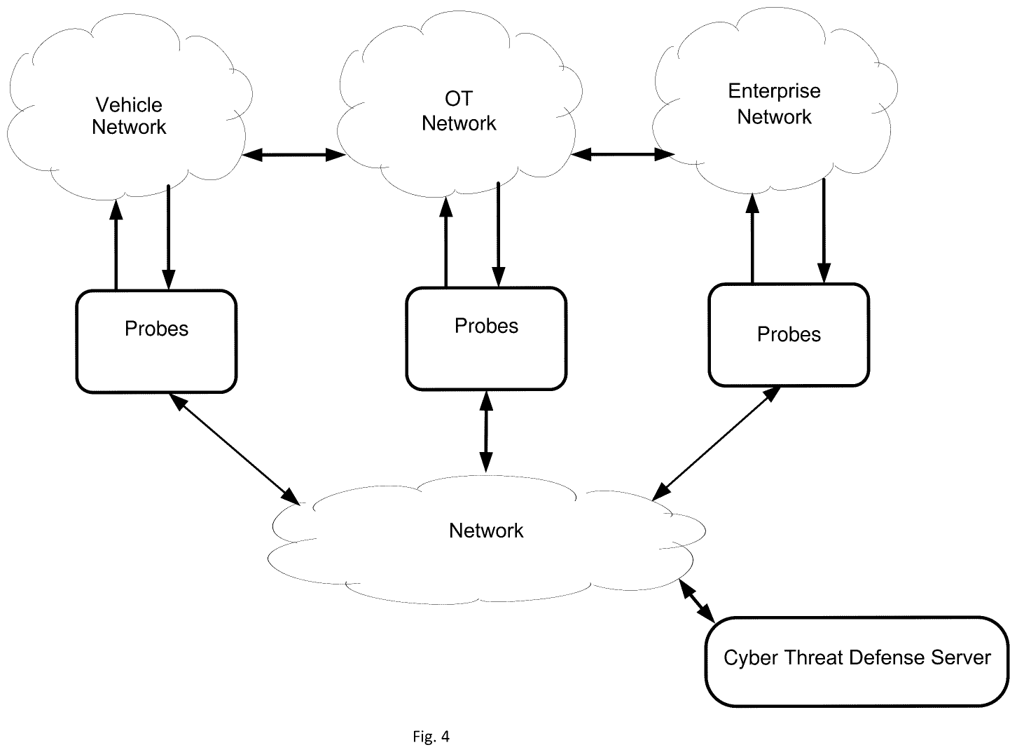

FIG. 3 illustrates a block diagram of an embodiment of a cyber threat defense systems monitoring an example vehicle network. FIG. 3 shows a vehicle network comprising a first vehicle 301 and a second vehicle 303, represented here by their central electronic control units (ECUs) upon which software is installed to communicate with a central cyber threat defense server 300 with its modules and machine-learning models. Similarly, FIG. 4 illustrates a block diagram of an embodiment of an example central cyber threat defense system 100 with its modules and machine-learning models using probes to monitor the vehicle network, an enterprise network and an OT network.

Organizations, such as vehicle manufacturers, rely on both their OT networks and their enterprise networks in order to deliver services. For example, an OT network may comprise devices within a factory where a vehicle, or components thereof, is assembled. An enterprise network may have connected to it various devices belonging to engineers and designers of the vehicle. The modules of the cyber threat defense system 100 are able to analyze activities in both OT networks in light of activities occurring in enterprise networks and then display both of their metrics, alerts, and events from each OT and enterprise network being monitored on a common display user interface. The vehicle module of the cyber threat defense system is able to analyze activities in the vehicle network in view of activities occurring in both the OT and enterprise networks, which, during the lifetime of a vehicle in the network, may be developing updates for the vehicle or manufacturing replacement parts for the vehicle. The graphical user-interface can be configured to be able to pivot between the metrics of the vehicle network, the OT network and the enterprise network. The structure and operation of cyber defense for all three networks is made possible by the cyber threat defense system 100. In this manner, cyber threat defense system 100 can protect a vehicle throughout its whole lifecycle, from conception and design (e.g., within the enterprise network), through manufacture (e.g., within the OT network) and use (e.g., within the vehicle network), to updates and repairs (e.g., across all three networks).

The cyber threat defense system 100 with the vehicle module, the OT module and the enterprise module can detect cyber threats occurring in each of a vehicle network, an OT network and an enterprise network as well as a cyber threat entering in one network and then affecting another network environment.

The vehicle module, OT module and enterprise module can cooperate to integrate both activities occurring in the vehicle network and the OT network as well as activities occurring in the enterprise network on the GUI at the same time. The vehicle module, OT module and enterprise module integrate countering and monitoring the vehicles of the vehicle network, the OT infrastructure and components in the enterprise infrastructure with i) machine-learning models and ii) being able to analyze all of the networks on the GUI and iii) with the various modules, all at the same time.

A vehicle network typically includes IP and Ethernet-based areas, especially in a central ECU that provides external connectivity over a network, such as to a cyber threat defense server, other vehicles, and the wider internet. Other transports and protocols, however, may also be used, particularly in dedicated controllers and firmware for various systems and components of a vehicle. An example of a non-IP/Ethernet communication technology is Controller Area Network (CAN). Probes may be installed into the vehicle such as at a central ECU, as well as at various other ECUs or other systems or components of a vehicle, such as a powertrain, entertainment unit and so on. These probes may report back to a central probe installed on a central ECU for relay back to the cyber threat defense server 300 so that the vehicle module has oversight and can detect cyber threats within each system of a vehicle covered by a probe.

The probes can ingest onboard traffic from any of sensors and other components within the vehicle system they integrate within order to obtain the data and meta data from one or more protocols and data types. The probe can ingest onboard traffic from any of sensors and other components directly, obtaining them from a component responsible for storing their data or meta data, and/or through an interface depending on the coded type of probe. The suite of probes communicates their data and/or meta data over a network to the centralized cyber threat defense server via a central probe.

The central probe can be coded to establish a secure communication mechanism to communicate and cooperate with the centralized cyber threat defense server. The secure communication mechanism may be, for example, a secure tunnel connection, such as an SSH tunnel and/or a private key connection, directly between the probe and the cyber threat defense server.

Often, many systems and controllers within a vehicle have limited processing power and limited storage capabilities. Accordingly, probes send data points to be fully analyzed on the cyber threat defense server. Thus, the probes may be coded to run a limited protocol analysis on network telemetry data within the vehicle systems that filters for relevant data and meta data from the protocol and data types; rather than, all data and metadata from network traffic within the vehicle system, and then feeds the relevant data and meta data through a secure communication mechanism over the network back to the centralized cyber threat defense server. The mixing in of some probe processing and some processing deferred to the central server occurs based on local resource and bandwidth to the central server constraints. The probe data gathers and sits resident on memory storage on the vehicle system and uses processing power and memory storage of the vehicle system in order to intelligently do some analysis to send back relevant data and meta data gathered to the cyber threat defense server. The cyber threat defense platform connects through an interface e.g. (API) to receive the network telemetry data and then perform the fuller version of protocol analysis.

The probe can be configured to sit resident in a memory storage device in the vehicle system. The probe can be coded as software storable in the memory storage device in the vehicle system in an executable format to be executed by a processor in the vehicle system to perform one or more functions of the probe, such as conveying one or more addresses and mapping details of an interface (e.g. API) of the centralized cyber threat defense server. Thus, communication components in the vehicle system cooperate with the probe to connect to the central cyber defense appliance through the interface (e.g. API) to send data and/or meta data; and then, the centralized cyber defense appliance has one or more protocol analyzers to perform a protocol analysis on the data and/or meta data from the protocols and data types utilized in any of 1) the layers of the vehicle system including the data link layer and 2) the physical layer, and then to feed the data and/or meta data into the one or more AI models. The probe can be coded to regularly push data and meta data to the cyber threat defense system 100.

In some implementations, some or all of the probes may be a mere data gather. An onboard probe can ingest telemetry data (primarily within-vehicle network data) and be a data gather that merely reports back a number of different types of metrics to analyze to determine when any of i) an abnormal behavior, ii) a suspicious activity, and iii) any combination of both is occurring in that vehicle system that the user/security team needs to be alerted to.

An OT network typically includes IP and Ethernet-based areas, but may also use other transports. An IP gateway is a device that converts traffic intended for the OT environment travelling over a TCP/IP network into an alternative media such as the Serial Communication protocol, and will also serve as a routing device. An example gateway device would have a single IP address and be contacted using, for example, the Modbus/TCP protocol. Coming out of the other side could be a dozen Serial lines (RS-485), which carry a serial-based protocol. Application layer information within the TCP/IP network traffic includes any additional information needed by the gateway to route data to the correct non-IP device.

The cyber threat defense system 100 can merely receive a copy of the IP traffic. In order to disambiguate between the final destinations of the traffic, the communications messaging detector can deep-read the addressing from inside the packets. No matter how many remaining hops the traffic may have to make, the final address must be encoded in the IP traffic. The communications messaging detector is configured to understand OT protocols that use IP networking technologies as well as TCP/IP network communications in order to also provide visibility into OT devices that are not attached to the TCP/IP network, as long as their communications enter the TCP/IP network at some point.

The cyber threat defense system 100 is effective across the whole organization, including OT and enterprise networks. The cyber threat defense system 100 allows an organization's security team to have a common solution, common capabilities and a common language for exchanging information.

Thus, the cyber threat defense system 100 is a self-learning attack detection system that operates across the entirety of corporate and industrial mechanisms (ICS/SCADA/etc.) in an organization e.g. the entirety of the heavy industry and corporate enterprise facilities, of for example, a vehicle factory.

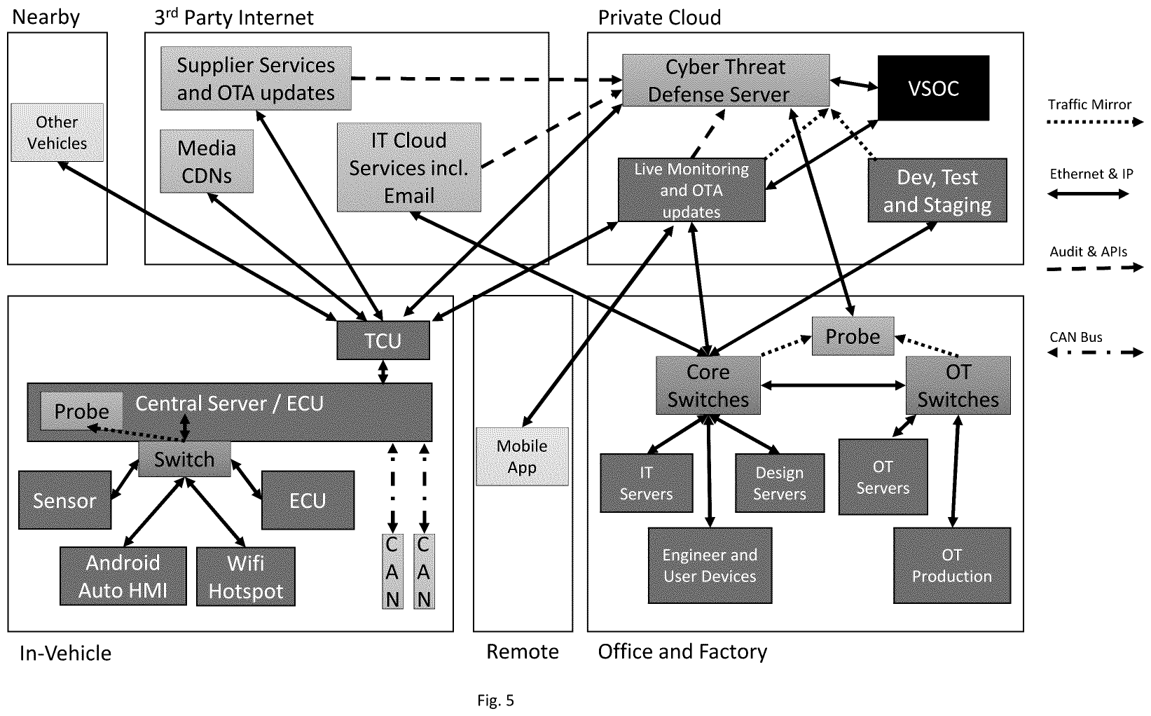

FIG. 5 illustrates the cyber threat defense system in more detail in the context of providing vehicle, enterprise (office), and OT (factory) protection. The vehicle connects to a network, such as the internet, via its telematics control unit (TCU). This provides connectivity to the rest of the cyber threat defense system, including the cyber threat defense server, other connected vehicles, and various other internet locations, such as media content providers and CDNs and suppliers of services and over the air (OTA) updates to the vehicle and its systems.

This high level of connectivity, while useful in increasing the functionality of the vehicle, increases the risk of a cyber threat penetrating the vehicle due to the greater exposure to the internet and number of attack vectors. Therefore, a probe of the cyber threat defense system is installed in the vehicle in the central ECU, which can monitor all network traffic into and out of the vehicle. This is the primary entry point for a cyber threat, and ultimately any cyber threat exfiltrating data or contacting external end points to receive instructions or the like will be detected by the probe in the central ECU as it monitors network traffic through the TCU. The probe can also monitor activity of other devices and systems in the vehicle, such as other ECUs for particular components or subsystems of a vehicle, such as an ECU for a powertrain, various sensors of the vehicle, such as cameras, and other computer systems of the vehicle depending upon how these systems are connected to the central ECU and the internal vehicle network architecture. In some cases, multiple probes may be installed in the vehicle, for example each ECU of the vehicle can have its own probe installed which may report directly back to the cyber threat defense server via the TCU or may report back to a central probe installed on the central ECU of the vehicle which then coordinates reporting back to the cyber threat defense server.

As well as protecting the vehicle itself from cyber threats, the cyber threat defense system protects the factory where the vehicle was made and the office environment where it was designed, in particular the OT and enterprise networks previously discussed herein respectively. Protecting these networks means that the entire lifecycle of a vehicle is protected, from conception and design, through manufacturing to sale, use, maintenance and decommission (or end-of-life), as required, for example, to comply with UN Regulation No. 155: “Cyber security and cyber security management system”, published on 4 Mar. 2021. This increases the overall security by preventing attacks or cyber threats against the vehicle throughout the lifecycle.

Within the OT and enterprise networks (i.e., within the office and factory environments) one or more cyber threat defense programs, such as one or more probes similar to that installed within the vehicle, are configured to receive and monitor network traffic within these networks. For example, the probes may be installed on various network switches within the networks. However, compared to the probes installed within the vehicle, probes within the office and factory environments will typically not have the same constraints on available resources, and may even be provided on their own dedicated hardware rather than being installed on existing hardware. They may also perform more processing and analysis themselves, locally within the OT and enterprise networks, but are still in communication with the central cyber threat defense server which coordinates and collates information from each of the networks to provide a holistic defense system and to train and updated the various AI and machine-learning models utilized by the cyber threat defense system. Aspects of the OT system may be monitored, such as network traffic and activity related to OT production (factory) equipment as well as OT servers related to the control and operation of such equipment. Aspects of the enterprise system may be monitored, including various IT servers supporting the network, design servers and other devices and systems used in the design of vehicles, and engineering and other user devices connected to the system.

The cyber threat defense system can also monitor a mobile application of a user associated with the vehicle. Typically, the level of visibility available to the cyber threat defense system of processes and traffic within a mobile device, such as a cellular telephone, will be relatively low compared to within the vehicle network, enterprise network, or OT network where the cyber threat defense system is highly integrated. Nevertheless, traffic associated with the mobile application, such as user credentials, requests sent to the vehicle, changes to access or administration privileges, or other changes made within the mobile application can be monitored and incorporated into the cyber threat defense system. The mobile application may, in some cases, be regarded as part of the vehicle network, typically being associated with a particular user and a particular vehicle, and a normal pattern of behavior may be established using the AI and machine-learning models of the vehicle module, or alternatively other or dedicated AI and machine-learning models of the cyber threat defense system may be utilized.

As well as the cyber threat defense server, the cyber threat defense system also comprises a virtual or vehicle security operations center (VSOC) manned by human cybersecurity personnel. Particularly given the limited autonomous responses available to remedy or mitigate detected cyber threats within a vehicle, as discussed above, having human cybersecurity personnel on hand can be a useful part of the cyber threat detection system. The human cybersecurity personnel are trained cybersecurity experts meaning that they are able to better understand a detected cyber threat, whereas typically a user of a vehicle will not be a trained cybersecurity expert. They may, for example, communicate with the user of a vehicle to explain in layman's terms that a cyber threat has been detected on the vehicle and direct the user to take appropriate action, such as proceeding to a service center. Due to the processing performed by the other parts of the cyber threat defense system, in particular the AI and machine-learning models that learn normal patterns of behavior and detect cyber threats by looking for deviations from these normal patterns of behavior, the number of human cybersecurity personnel needed to operate the virtual security operations center is greatly reduced compared to legacy cybersecurity systems because the cyber threat defense system utilizes a much more intelligent approach to detecting potential threats and its detection engineering. Equivalently, for the same size human team, far more potential threats can be investigated utilizing the combined resources of the cyber threat defense system and the human cybersecurity personnel than if the human cybersecurity personnel were using a legacy cybersecurity system.

### The Basics of an Example Cyber Threat Defense System

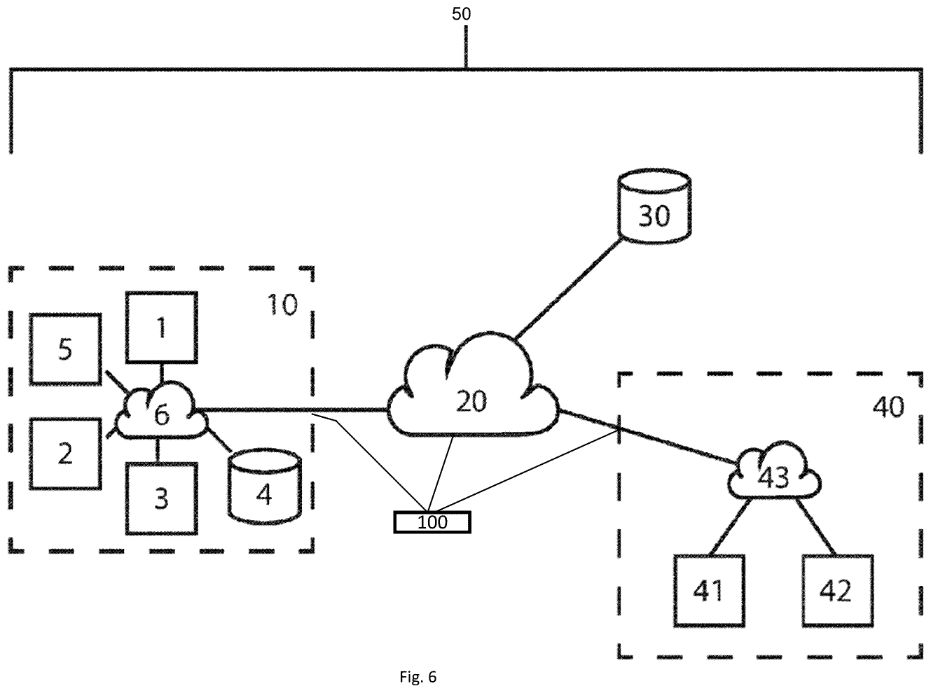

FIG. 6 illustrates an example cyber threat defense system, including the cyber threat defense system and its extensions, protecting an example network. The example network FIG. 6 illustrates a network of computer systems 50 using one or more cyber threat defense systems 100. The system depicted by FIG. 6 is a simplified illustration, which is provided for ease of explanation of the invention. The system 50 comprises a first computer system 10 within a vehicle, which uses the threat detection system to detect and thereby attempt to prevent threats to computing devices within its bounds. The first computer system 10 comprises three computers 1, 2, 3, a local server 4 (e.g., a central ECU), and an entertainment system 5. All of the devices within the first computer system 10 are communicatively coupled via a Local Area Network 6 (i.e., a within-vehicle network). Consequently, all of the computers 1, 2, 3 are able to access the local server 4 via the LAN 6 and use the functionalities of the entertainment system 5 via the LAN 6.

The LAN 6 of the first computer system 10 is connected to the Internet 20, which in turn provides computers 1, 2, 3 with access to a multitude of other computing devices including server 30 and second computer system 40. Second computer system 40 also includes two computers 41, 42, connected by a second LAN 43.

In this exemplary embodiment of the invention, computer 41 on the second computer system 20 has the threat detection system and runs the threat detection method for detecting threats to the first computer system, i.e., the vehicle. As such, it comprises a processor arranged to run the steps of the process described herein, memory required to store information related to the running of the process, as well as a network interface for collecting the required information. This method shall now be described in detail with reference to FIG. 6.

The computer 41 builds and maintains a dynamic, ever-changing model of the ‘normal behavior’ of each user and machine within the system 10. The approach is based on Bayesian mathematics, and monitors all interactions, events and communications within the system 10 viewable to computer 41 (e.g., reported by probes).

The threat detection system is built to deal with the fact that today's attackers are getting stealthier and an attacker may be ‘hiding’ in a system to ensure that they avoid raising suspicion in an end user, such as by slowing their machine down, using normal software protocol. Any attack process thus stops or ‘backs off’ automatically if a system is used. However, yet more sophisticated attacks try the opposite, hiding in memory under the guise of a normal process and stealing CPU cycles only when the machine is active, in an attempt to defeat a relatively-simple policing process. These sophisticated attackers look for activity that is not directly associated with the user's input. As an APT (Advanced Persistent Threat) attack typically has very long mission windows of weeks, months or years, such processor cycles can be stolen so infrequently that they do not impact machine performance. But, however cloaked and sophisticated the attack is, there will always be a measurable delta, even if extremely slight, in typical machine behavior, between pre and post compromise. This behavioral delta can be observed and acted on with the form of Bayesian mathematical analysis used by the threat detection system installed on the computer 1.

The cyber defense self-learning platform uses machine-learning technology. The machine-learning technology, using advanced mathematics, can detect previously unidentified threats, without rules, and automatically defend networks. Note, today's attacks can be of such severity and speed that a human response cannot happen quickly enough. Thanks to these self-learning advances, it is now possible for a machine to uncover emerging threats and deploy appropriate, real-time responses to fight back against the most serious cyber threats.

The cyber threat defense system builds a sophisticated ‘pattern of life’—that understands what represents normality for every person, device, and network activity in the system being protected by the cyber threat defense system.

The threat detection system has the ability to self-learn and detect normality in order to spot true anomalies, allowing organizations of all sizes to understand the behavior of vehicles, users and machines on their networks at both an individual and group level. Monitoring behaviors, rather than using predefined descriptive objects and/or signatures, means that more attacks can be spotted ahead of time and extremely subtle indicators of wrongdoing can be detected. Unlike traditional legacy defenses, a specific attack type or new malware does not have to have been seen first before it can be detected. A behavioral defense approach mathematically models both machine and human activity behaviorally, at and after the point of compromise, in order to predict and catch today's increasingly sophisticated cyber-attack vectors. It is thus possible to computationally establish what is normal, in order to then detect what is abnormal.

This intelligent system is capable of making value judgments and carrying out higher value, more thoughtful tasks. Machine learning requires complex algorithms to be devised and an overarching framework to interpret the results produced. However, when applied correctly these approaches can facilitate machines to make logical, probability-based decisions and undertake thoughtful tasks.

Advanced machine-learning is at the forefront of the fight against automated and human-driven cyber-threats, overcoming the limitations of rules and signature-based approaches:
The machine-learning learns what is normal within a network—it does not depend upon knowledge of previous attacks.
The machine-learning thrives on the scale, complexity and diversity of modern networks, where every device and person is slightly different.
The machine-learning turns the innovation of attackers against them—any unusual activity is visible.
The machine-learning constantly revisits assumptions about behavior, using probabilistic mathematics.
The machine-learning is always up to date and not reliant on human input.

Utilizing machine-learning in cyber security technology is difficult, but when correctly implemented it is extremely powerful. The machine-learning means that previously unidentified threats can be detected, even when their manifestations fail to trigger any rule set or signature. Instead, machine-learning allows the system to analyze large sets of data and learn a ‘pattern of life’ for what it sees.

Machine learning can approximate some human capabilities to machines, such as:
Thought: it uses past information and insights to form its judgments;
Real time: the system processes information as it goes; and
Self-improving: the model's machine-learning understanding is constantly being challenged and adapted, based on new information.

New unsupervised machine-learning therefore allows computers to recognize evolving threats, without prior warning or supervision.

### Unsupervised Machine-Learning

Unsupervised learning works things out without pre-defined labels. In the case of sorting the series of different animals, the system analyzes the information and works out the different classes of animals. This allows the system to handle the unexpected and embrace uncertainty. The system does not always know what it is looking for, but can independently classify data and detect compelling patterns.

The cyber threat defense system's unsupervised machine-learning methods do not require training data with pre-defined labels. Instead, they are able to identify key patterns and trends in the data, without the need for human input. The advantage of unsupervised learning is that it allows computers to go beyond what their programmers already know and discover previously unknown relationships.

The cyber threat defense system uses unique implementations of unsupervised machine-learning algorithms to analyze network data at scale, intelligently handle the unexpected, and embrace uncertainty. Instead of relying on knowledge of past threats to be able to know what to look for, it is able to independently classify data and detect compelling patterns that define what may be considered to be normal behavior. Any new behaviors that deviate from those, which constitute this notion of ‘normality,’ may indicate threat or compromise. The impact of the cyber threat defense system's unsupervised machine-learning on cyber security is transformative:
Threats from within, which would otherwise go undetected, can be spotted, highlighted, contextually prioritized and isolated using these algorithms.
The application of machine-learning has the potential to provide total network visibility and far greater detection levels, ensuring that networks have an internal defense mechanism.
Machine learning has the capability to learn when to action automatic responses against the most serious cyber threats, disrupting in progress attacks before they become a crisis for the organization.

This new mathematics not only identifies meaningful relationships within data, but also quantifies the uncertainty associated with such inference. By knowing and understanding this uncertainty, it becomes possible to bring together many results within a consistent framework—the basis of Bayesian probabilistic analysis. The mathematics behind machine-learning is extremely complex and difficult to get right. Robust, dependable algorithms are developed, with a scalability that enables their successful application to real-world environments.

### Overview

Training of AI Pre-Deployment and then During Deployment

In step 1, an initial training of the Artificial Intelligence model trained on cyber threats can occur using unsupervised learning and/or supervised learning on characteristics and attributes of known potential cyber threats including malware, insider threats, and other kinds of cyber threats that can occur within that domain. Each Artificial Intelligence model (e.g. neural network, decision tree, etc.) can be programmed and configured with the background information to understand and handle particulars, including different types of data, protocols used, types of devices, user accounts, etc. of the system being protected. The Artificial Intelligence pre-deployment can all be trained on the specific machine learning task that they will perform when put into deployment. For example, the AI model, such as AI model(s) 160 or example (hereinafter “AI model(s) 160”), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, one of the AI models 160 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cyber security appliance 100, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyberattacks.

In an embodiment, one or more of the AI models 160 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level of the vehicle and its protocols, and at the user/driver level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the vehicle domain under analysis.

Thus, a deployed Artificial Intelligence model 160 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user/driver/operator account, each electronic computing system, etc.). Initial training of one or more Artificial Intelligence models 160 trained with machine learning on a normal behavior of the pattern of life of the entities in the vehicle domain can occur where the vehicle domain generally has some common typical behavior with each model trained specifically to understand components/devices, protocols, activity level, etc. to that type of the vehicle domain. Alternatively, pre-deployment machine learning training of one or more Artificial Intelligence models trained on a normal pattern of life of entities in the system can occur. Initial training of one or more Artificial Intelligence models trained with machine learning on a normal behavior of the pattern of life of the entities in the network/domain can occur where the the vehicle domain generally has some common typical behavior with each model trained specifically to understand components/devices, protocols, activity level, etc. to the vehicle domain. What is the normal behavior of each entity within that system can be established either prior to the deployment and then adjusted during deployment or alternatively the model can simply be placed into an observation mode for an initial week or two when first deployed on a network/domain in order to establish an initial normal behavior for entities in the network/domain under analysis. During the deployment of the model, what is considered normal behavior will change as each different entity's behavior changes and will be reflected through the use of unsupervised learning in the model such as various Bayesian techniques, clustering, etc. Again, the AI models 160 can be implemented with various mechanisms, such neural networks, decision trees, etc. and combinations of these. Likewise, one or more supervised machine learning AI models 160 may be trained to create possible hypotheses and perform cyber threat investigations on agnostic examples of past historical incidents of detecting a multitude of possible types of cyber threat hypotheses previously analyzed by human cyber security analyst.

At its core, the self-learning AI models 160 that model the normal behavior (e.g. a normal pattern of life) of entities in the network mathematically characterizes what constitutes ‘normal’ behavior, based on the analysis of a large number of different measures of a device's network behavior—data traffic and network activity/processes including access, data volumes, timings of events, credential use, connection type, volume, and directionality of, for example, uploads/downloads of data into the vehicle network, file type, packet intention, admin activity, resource and information requests, command sent, etc.

### Clustering Methods

In order to model what should be considered as normal for a device or cloud container, its behavior can be analyzed in the context of other similar entities on the network. The AI models (e.g., AI model(s) 160) can use unsupervised machine learning to algorithmically identify significant groupings, a task which is virtually impossible to do manually. To create a holistic image of the relationships within the network, the AI models and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The AI models and AI classifiers can employ a large-scale computational approach to understand sparse structure in models of network connectivity based on applying L1—regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning AI models are trained to create possible hypotheses and how to perform cyber threat investigations on agnostic examples of past historical incidents of detecting a multitude of possible types of cyber threat hypotheses previously analyzed by human cyber threat analysis. AI models 160 trained on forming and investigating hypotheses on what are a possible set of cyber threats can be trained initially with supervised learning. Thus, these AI models 160 can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful. More on the training of the AI models that are trained to create one or more possible hypotheses and perform cyber threat investigations will be discussed later.

Next, the various Artificial Intelligence models and AI classifiers combine use of unsupervised and supervised machine learning to learn ‘on the job’ —it does not depend upon solely knowledge of previous cyber threat attacks. The Artificial Intelligence models and classifiers combine use of unsupervised and supervised machine learning constantly revises assumptions about behavior, using probabilistic mathematics, that is always up to date on what a current normal behavior is, and not solely reliant on human input. The Artificial Intelligence models and classifiers combine use of unsupervised and supervised machine learning on cyber security is capable of seeing hitherto undiscovered cyber events, from a variety of threat sources, which would otherwise have gone unnoticed. Next, these cyber threats can include, for example: Insider threat—malicious or accidental, Zero-day attacks—previously unseen, novel exploits, latent vulnerabilities, machine-speed attacks—ransomware and other automated attacks that propagate and/or mutate very quickly, Cloud and SaaS-based attacks, other silent and stealthy attacks advance persistent threats, advanced spear-phishing, etc.

### Ranking the Cyber Threat

The assessment module 125 and/or cyber threat analyst module 120 of FIG. 4 can cooperate with the AI model(s) 160 trained on possible cyber threats to use AI algorithms to account for ambiguities by distinguishing between the subtly differing levels of evidence that characterize network data. Instead of generating the simple binary outputs ‘malicious’ or ‘benign’, the AI's mathematical algorithms produce outputs marked with differing degrees of potential threat. This enables users of the system to rank alerts and notifications to the enterprise security administrator in a rigorous manner, and prioritize those which most urgently require action. Meanwhile, it also assists to avoid the problem of numerous false positives associated with simply a rule-based approach.

In an embodiment, a closer look at the cyber threat defense system's machine-learning algorithms and approaches is as follows.

The cyber threat defense system's probabilistic approach to cyber security is based on a Bayesian framework. This allows it to integrate a huge number of weak indicators of potentially anomalous network behavior to produce a single clear measure of how likely a network device is to be compromised. This probabilistic mathematical approach provides an ability to understand important information, amid the noise of the network—even when it does not know what it is looking for.

### Ranking Threats

Crucially, the cyber threat defense system's approach accounts for the inevitable ambiguities that exist in data, and distinguishes between the subtly differing levels of evidence that different pieces of data may contain. Instead of generating the simple binary outputs ‘malicious’ or ‘benign,’ the cyber threat defense system's mathematical algorithms produce outputs that indicate differing degrees of potential compromise. This output enables users of the system to rank different alerts in a rigorous manner and prioritize those that most urgently require action, simultaneously removing the problem of numerous false positives associated with a rule-based approach.

At its core, the cyber threat defense system mathematically characterizes what constitutes ‘normal’ behavior based on the analysis of a large number/set of different measures of a devices network behavior, examples include:
Server access; Data access; Timings of events; Credential use; DNS requests; and other similar parameters.

Each measure of network behavior is then monitored in real time to detect anomalous behaviors.

### Clustering

To be able to properly model what should be considered as normal for a device, its behavior must be analyzed in the context of other similar devices on the network. To accomplish this, the cyber threat defense system leverages the power of unsupervised learning to algorithmically identify naturally occurring groupings of devices, a task which is impossible to do manually on even modestly sized networks.

In order to achieve as holistic a view of the relationships within the network as possible, the cyber threat defense system simultaneously employs a number of different clustering methods including matrix based clustering, density based clustering and hierarchical clustering techniques. The resulting clusters are then used to inform the modeling of the normative behaviors of individual devices.

Clustering: At a glance:
Analyzes behavior in the context of other similar devices on the network;
Algorithms identify naturally occurring groupings of devices—impossible to do manually; and
Simultaneously runs a number of different clustering methods to inform the models.

### Network Topology

Any cyber threat detection system must also recognize that a network is far more than the sum of its individual parts, with much of its meaning contained in the relationships among its different entities, and that complex threats can often induce subtle changes in this network structure. To capture such threats, the cyber threat defense system employs several different mathematical methods in order to be able to model multiple facets of a networks topology.

One approach is based on iterative matrix methods that reveal important connectivity structures within the network. In tandem with these, the cyber threat defense system has developed innovative applications of models from the field of statistical physics, which allow the modeling of a network's ‘energy landscape’ to reveal anomalous substructures that may be concealed within.

### Network Structure

A further important challenge in modeling the behaviors of network devices, as well as of networks themselves, is the high-dimensional structure of the problem with the existence of a huge number of potential predictor variables. Observing packet traffic and host activity within an enterprise LAN, WAN and Cloud is difficult because both input and output can contain many inter-related features (protocols, source and destination machines, log changes and rule triggers, etc.). Learning a sparse and consistent structured predictive function is crucial to avoid the curse of over fitting.

In this context, the cyber threat defense system has employed a cutting edge large-scale computational approach to learn sparse structure in models of network behavior and connectivity based on applying L1-regularization techniques (e.g. a lasso method). This allows for the discovery of true associations between different network components and events that can be cast as efficiently solvable convex optimization problems and yield parsimonious models.

### Recursive Bayesian Estimation

To combine these multiple analyses of different measures of network behavior to generate a single comprehensive picture of the state of each device, the cyber threat defense system takes advantage of the power of Recursive Bayesian Estimation (RBE) via an implementation of the Bayes filter.

Using RBE, the cyber threat defense system's mathematical models are able to constantly adapt themselves, in a computationally efficient manner, as new information becomes available to the system. They continually recalculate threat levels in the light of new evidence, identifying changing attack behaviors where conventional signature-based methods fall down.

The cyber threat defense system's innovative approach to cyber security has pioneered the use of Bayesian methods for tracking changing device behaviors and computer network structures. The core of the cyber threat defense system's mathematical modeling is the determination of normative behavior, enabled by a sophisticated software platform that allows for its mathematical models to be applied to new network data in real time. The result is a system that is able to identify subtle variations in machine events within a computer networks behavioral history that may indicate cyber-threat or compromise.

The cyber threat defense system uses mathematical analysis and machine-learning to detect potential threats, allowing the system to stay ahead of evolving risks. The cyber threat defense system approach means that detection no longer depends on an archive of previous attacks. Instead, attacks can be spotted against the background understanding of what represents normality within a network. No pre-definitions are needed, which allows for the best possible insight and defense against today's threats. On top of the detection capability, the cyber threat defense system can create digital antibodies automatically, as an immediate response to the most threatening cyber breaches. The cyber threat defense system approach both detects and defends against cyber threat. Genuine unsupervised machine-learning eliminates the dependence on signature-based approaches to cyber security, which are not working. The cyber threat defense system's technology can become a vital tool for security teams attempting to understand the scale of their network, observe levels of activity, and detect areas of potential weakness. These no longer need to be manually sought out, but are flagged by the automated system and ranked in terms of their significance.

Machine learning technology is the fundamental ally in the defense of systems from the hackers and insider threats of today, and in formulating response to unknown methods of cyber-attack. It is a momentous step change in cyber security. Defense must start within.

### An Example Method

The threat detection system shall now be described in further detail with reference to a flow of the process carried out by the threat detection system for automatic detection of cyber threats through probabilistic change in normal behavior through the application of an unsupervised Bayesian mathematical model to detect behavioral change in computers and computer networks.

The core threat detection system is termed the ‘Bayesian probabilistic’. The Bayesian probabilistic is a Bayesian system of automatically determining periodicity in multiple time series data and identifying changes across single and multiple time series data for the purpose of anomalous behavior detection.

Human, machine or other activity is modeled by initially ingesting data from a number of sources at step S1 and deriving second order metrics at step S2 from that raw data.

The raw data sources include, but are not limited to:
Raw network IP traffic captured from an IP or other network TAP or SPAN port;
Machine generated log files;
Building access (“swipe card”) systems;
IP or non IP data flowing over a vehicle network;
Individual machine, peripheral or component power usage;
Telecommunication signal strength; and/or
Machine level performance data taken from on-host sources (CPU usage/memory usage/disk usage/disk free space/network usage/etc.)

From these raw sources of data, a large number of metrics can be derived each producing time series data for the given metric. The data are bucketed into individual time slices (for example, the number observed could be counted per 1 second, per 10 seconds or per 60 seconds), which can be combined at a later stage where required to provide longer range values for any multiple of the chosen internal size. For example, if the underlying time slice chosen is 60 seconds long, and thus each metric time series stores a single value for the metric every 60 seconds, then any new time series data of a fixed multiple of 60 seconds (120 seconds, 180 seconds, 600 seconds etc.) can be computed with no loss of accuracy. Metrics are chosen directly and fed to the Bayesian probabilistic by a lower order model which reflects some unique underlying part of the data, and which can be derived from the raw data with particular domain knowledge. The metrics that are obtained depends on the threats that the system is looking for. In order to provide a secure system, it is common for a large number of metrics relating to a wide range of potential threats to be obtained. Communications from components in the network contacting known suspect domains.

The actual metrics used are largely irrelevant to the Bayesian probabilistic system, which is described here, but some examples are provided below.

Metrics derived from network traffic could include data such as:
The number of bytes of data entering or leaving a networked device per time interval.
File access.
The commonality/rarity of a communications process
Invalid SSL certification.
Failed authorization attempt.
Email access patterns.

In the case where TCP, UDP or other Transport Layer IP protocols are used over the IP network, and in cases where alternative Internet Layer protocols are used (e.g. ICMP, IGMP), knowledge of the structure of the protocol in use and basic packet header analysis can be utilized to generate further metrics, such as:
The number of multicasts per time interval originating from a networked device and intended to reach publicly addressable IP ranges.
The number of internal link-local IP Broadcast requests originating from a networked device.
The size of the packet payload data.
The number of individual TCP connections made by a device, or data transferred by a device, either as a combined total across all destinations or to any definable target network range, (e.g. a single target machine, or a specific network range)

In the case of IP traffic, in the case where the Application Layer protocol can be determined and analyzed, further types of time series metric can be defined, for example:
The number of DNS requests a networked device generates per time interval, again either to any definable target network range or in total.
The number of SMTP, POP or IMAP logins or login failures a machine generates per time interval.
The number of LDAP logins or login failures a generated.
Data transferred via file sharing protocols such as SMB, SMB2, FTP, etc.
Logins to Microsoft Windows Active Directory, SSH or Local Logins to Linux or Unix Like systems, or other authenticated systems such as Kerberos.

The raw data required to obtain these metrics may be collected via a passive fiber or copper connection to the networks internal switch gear, from virtual switching implementations, from cloud based systems, or from communicating devices themselves. Ideally the system receives a copy of every communications packet to provide full coverage of an organization.

For other sources, a number of domain specific time series data are derived, each chosen to reflect a distinct and identifiable facet of the underlying source of the data, which in some way reflects the usage or behavior of that system over time.

Many of these time series data are extremely sparse, and have the vast majority of data points equal to 0. Examples would be employee's using swipe cards to access a building or part of a building, or user's logging into their workstation, authenticated by Microsoft Windows Active Directory Server, which is typically performed a small number of times per day. Other time series data are much more populated, for example the size of data moving to or from an always-on Web Server, the Web Servers CPU utilization, or the power usage of a photocopier.

Regardless of the type of data, it is extremely common for such time series data, whether originally produced as the result of explicit human behavior or an automated computer or other system to exhibit periodicity, and have the tendency for various patterns within the data to recur at approximately regular intervals. Furthermore, it is also common for such data to have many distinct but independent regular time periods apparent within the time series.

At step S3, detectors carry out analysis of the second order metrics. Detectors are discrete mathematical models that implement a specific mathematical method against different sets of variables with the target network. For example, HMM may look specifically at the size and transmission time of packets between nodes. The detectors are provided in a hierarchy that is a loosely arranged pyramid of models. Each detector model effectively acts as a filter and passes its output to another model higher up the pyramid. At the top of the pyramid is the Bayesian probabilistic that is the ultimate threat decision making model. Lower order detectors each monitor different global attributes or ‘features’ of the underlying network and or computers. These attributes consist of value over time for all internal computational features such as packet velocity and morphology, endpoint file system values, and TCP/IP protocol timing and events. Each detector is specialized to record and make decisions on different environmental factors based on the detectors own internal mathematical model such as an HMM.

While the threat detection system may be arranged to look for any possible threat, in practice the system may keep watch for one or more specific threats depending on the network in which the threat detection system is being used. For example, the threat detection system provides a way for known features of the network such as desired compliance and Human Resource policies to be encapsulated in explicitly defined heuristics or detectors that can trigger when in concert with set or moving thresholds of probability abnormality coming from the probability determination output. The heuristics are constructed using complex chains of weighted logical expressions manifested as regular expressions with atomic objects that are derived at run time from the output of data measuring/tokenizing detectors and local contextual information. These chains of logical expression are then stored in and/or on online libraries and parsed in real-time against output from the measures/tokenizing detectors. An example policy could take the form of “alert me if any employee subject to HR disciplinary circumstances (contextual information) is accessing sensitive information (heuristic definition) in a manner that is anomalous when compared to previous behavior (Bayesian probabilistic output)”. In other words, different arrays of pyramids of detectors are provided for detecting particular types of threats.

The analysis performed by the detectors on the second order metrics then outputs data in a form suitable for use with the model of normal behavior. As will be seen, the data is in a form suitable for comparing with the model of normal behavior and for updating the model of normal behavior.

At step S4, the threat detection system computes a threat risk parameter indicative of a likelihood of there being a threat using automated adaptive periodicity detection mapped onto observed behavioral pattern-of-life analysis. This deduces that a threat over time exists from a collected set of attributes that themselves have shown deviation from normative collective or individual behavior. The automated adaptive periodicity detection uses the period of time the Bayesian probabilistic has computed to be most relevant within the observed network and/or machines. Furthermore, the pattern of life analysis identifies how a human and/or machine behaves over time, i.e. when they typically start and stop work. Since these models are continually adapting themselves automatically, they are inherently harder to defeat than known systems. The threat risk parameter is a probability of there being a threat in certain arrangements. Alternatively, the threat risk parameter is a value representative of there being a threat, which is compared against one or more thresholds indicative of the likelihood of a threat.

In practice, the step of computing the threat involves comparing current data collected in relation to the user with the model of normal behavior of the user and system being analyzed. The current data collected relates to a period in time, this could be in relation to a certain influx of new data or a specified period of time from a number of seconds to a number of days. In some arrangements, the system is arranged to predict the expected behavior of the system. The expected behavior is then compared with actual behavior in order to determine whether there is a threat.

The system uses machine-learning/AI to understand what is normal inside a company's network, and when something's not normal. The system then invokes automatic responses to disrupt the cyber-attack until the human team can catch up. This could include interrupting connections, preventing the sending of malicious emails, preventing file access, preventing communications outside of the organization, etc. The approach begins in as surgical and directed way as possible to interrupt the attack without affecting the normal behavior of say a laptop, but if the attack escalates, it may ultimately become necessary to quarantine a device to prevent wider harm to an organization.

In order to improve the accuracy of the system, a check can be carried out in order to compare current behavior of a user with associated users, i.e. users within a single office. For example, if there is an unexpectedly low level of activity from a user, this may not be due to unusual activity from the user, but could be due to a factor affecting the office as a whole. Various other factors can be taken into account in order to assess whether or not abnormal behavior is actually indicative of a threat.

Finally, at step S5 a determination is made, based on the threat risk parameter, as to whether further action need be taken regarding the threat. This determination may be made by a human operator after being presented with a probability of there being a threat, or an algorithm may make the determination, e.g. by comparing the determined probability with a threshold.

In one arrangement, given the unique global input of the Bayesian probabilistic, a form of threat visualization is provided in which the user can view the threat landscape across all internal traffic and do so without needing to know how their internal network is structured or populated and in such a way as a ‘universal’ representation is presented in a single pane no matter how large the network. A topology of the network under scrutiny is projected automatically as a graph based on device communication relationships via an interactive 3D user interface. The projection is able to scale linearly to any node scale without prior seeding or skeletal definition.

The threat detection system that has been discussed above therefore implements a propriety form of recursive Bayesian estimation to maintain a distribution over the probability state variable. This distribution is built from the complex set of low-level host, network and traffic observations or ‘features’. These features are recorded iteratively and processed in real time on the platform. A plausible representation of the relational information among entities in dynamic systems in general, such as an enterprise network, a living cell or a social community, or indeed the entire internet, is a stochastic network, which is topological rewiring and semantically evolving over time. In many high-dimensional structured I/O problems, such as the observation of packet traffic and host activity within a distributed digital enterprise, where both input and output can contain tens of thousands, sometimes even millions of interrelated features (data transport, host-web-client dialogue, log change and rule trigger, etc.), learning a sparse and consistent structured predictive function is challenged by a lack of normal distribution. To overcome this, the threat detection system consists of a data structure that decides on a rolling continuum rather than a stepwise method in which recurring time cycles such as the working day, shift patterns and other routines are dynamically assigned. Thus providing a non-frequentist architecture for inferring and testing causal links between explanatory variables, observations and feature sets. This permits an efficiently solvable convex optimization problem and yield parsimonious models. In such an arrangement, the threat detection processing may be triggered by the input of new data. Alternatively, the threat detection processing may be triggered by the absence of expected data. In some arrangements, the processing may be triggered by the presence of a particular actionable event.

The method and system are arranged to be performed by one or more processing components with any portions of software stored in an executable format on a computer readable medium. The computer readable medium may be non-transitory and does not include radio or other carrier waves. The computer readable medium could be, for example, a physical computer readable medium such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

The various methods described above may be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

An apparatus such as a computer may be configured in accordance with such code to perform one or more processes in accordance with the various methods discussed herein.

### Web Site

The web site is configured as a browser-based tool or direct cooperating app tool for configuring, analyzing, and communicating with the cyber threat defense system.

### Network

A number of electronic systems and devices can communicate with each other in a network environment. The network environment has a communications network. The network can include one or more networks selected from an optical network, a cellular network, the Internet, a Local Area Network (“LAN”), a Wide Area Network (“WAN”), a satellite network, a 3^{rd} party ‘cloud’ environment; a fiber network, a cable network, and combinations thereof. In some embodiments, the communications network is the Internet. There may be many server computing systems and many client computing systems connected to each other via the communications network.

The communications network can connect one or more server computing systems selected from at least a first server computing system and a second server computing system to each other and to at least one or more client computing systems as well. The server computing systems can each optionally include organized data structures such as databases. Each of the one or more server computing systems can have one or more virtual server computing systems, and multiple virtual server computing systems can be implemented by design. Each of the one or more server computing systems can have one or more firewalls and similar defenses to protect data integrity.

At least one or more client computing systems for example, a mobile computing device (e.g., smartphone with an Android-based operating system) can communicate with the server(s). The client computing system can include, for example, the software application or the hardware-based system in which may be able exchange communications with the first electric personal transport vehicle, and/or the second electric personal transport vehicle. Each of the one or more client computing systems can have one or more firewalls and similar defenses to protect data integrity.

A cloud provider platform may include one or more of the server computing systems. A cloud provider can install and operate application software in a cloud (e.g., the network such as the Internet) and cloud users can access the application software from one or more of the client computing systems. Generally, cloud users that have a cloud-based site in the cloud cannot solely manage a cloud infrastructure or platform where the application software runs. Thus, the server computing systems and organized data structures thereof can be shared resources, where each cloud user is given a certain amount of dedicated use of the shared resources. Each cloud user's cloud-based site can be given a virtual amount of dedicated space and bandwidth in the cloud. Cloud applications can be different from other applications in their scalability, which can be achieved by cloning tasks onto multiple virtual machines at run-time to meet changing work demand. Load balancers distribute the work over the set of virtual machines. This process is transparent to the cloud user, who sees only a single access point.

Cloud-based remote access can be coded to utilize a protocol, such as Hypertext Transfer Protocol (“HTTP”), to engage in a request and response cycle with an application on a client computing system such as a web-browser application resident on the client computing system. The cloud-based remote access can be accessed by a smartphone, a desktop computer, a tablet, or any other client computing systems, anytime and/or anywhere. The cloud-based remote access is coded to engage in 1) the request and response cycle from all web browser based applications, 2) the request and response cycle from a dedicated on-line server, 3) the request and response cycle directly between a native application resident on a client device and the cloud-based remote access to another client computing system, and 4) combinations of these.

In an embodiment, the server computing system can include a server engine, a web page management component, a content management component, and a database management component. The server engine can perform basic processing and operating-system level tasks. The web page management component can handle creation and display or routing of web pages or screens associated with receiving and providing digital content and digital advertisements. Users (e.g., cloud users) can access one or more of the server computing systems by means of a Uniform Resource Locator (“URL”) associated therewith. The content management component can handle most of the functions in the embodiments described herein. The database management component can include storage and retrieval tasks with respect to the database, queries to the database, and storage of data.

In some embodiments, a server computing system can be configured to display information in a window, a web page, or the like. An application including any program modules, applications, services, processes, and other similar software executable when executed on, for example, the server computing system, can cause the server computing system to display windows and user interface screens in a portion of a display screen space. With respect to a web page, for example, a user via a browser on the client computing system can interact with the web page, and then supply input to the query/fields and/or service presented by the user interface screens. The web page can be served by a web server, for example, the server computing system, on any Hypertext Markup Language (“HTML”) or Wireless Access Protocol (“WAP”) enabled client computing system (e.g., the client computing system 802B) or any equivalent thereof. The client computing system can host a browser and/or a specific application to interact with the server computing system. Each application has a code scripted to perform the functions that the software component is coded to carry out such as presenting fields to take details of desired information. Algorithms, routines, and engines within, for example, the server computing system can take the information from the presenting fields and put that information into an appropriate storage medium such as a database (e.g., database). A comparison wizard can be scripted to refer to a database and make use of such data. The applications may be hosted on, for example, the server computing system and served to the specific application or browser of, for example, the client computing system. The applications then serve windows or pages that allow entry of details.

### Computing Systems

A computing system can be, wholly or partially, part of one or more of the server or client computing devices in accordance with some embodiments. Components of the computing system can include, but are not limited to, a processing unit having one or more processing cores, a system memory, and a system bus that couples various system components including the system memory to the processing unit. The system bus may be any of several types of bus structures selected from a memory bus or memory controller, a peripheral bus, and a local bus using any of a variety of bus architectures.

The computing system typically includes a variety of computing machine-readable media. Computing machine-readable media can be any available media that can be accessed by computing system and includes both volatile and nonvolatile media, and removable and non-removable media. By way of example, and not limitation, computing machine-readable media use includes storage of information, such as computer-readable instructions, data structures, other executable software or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device. Transitory media, such as wireless channels, are not included in the machine-readable media. Communication media typically embody computer readable instructions, data structures, other executable software, or other transport mechanism and includes any information delivery media.

The system memory includes computer storage media in the form of volatile and/or nonvolatile memory such as read only memory (ROM) and random access memory (RAM). A basic input/output system (BIOS) containing the basic routines that help to transfer information between elements within the computing system, such as during start-up, is typically stored in ROM. RAM typically contains data and/or software that are immediately accessible to and/or presently being operated on by the processing unit. By way of example, and not limitation, the RAM can include a portion of the operating system, application programs, other executable software, and program data.

The drives and their associated computer storage media discussed above, provide storage of computer readable instructions, data structures, other executable software and other data for the computing system.

A user may enter commands and information into the computing system through input devices such as a keyboard, touchscreen, or software or hardware input buttons, a microphone, a pointing device and/or scrolling input component, such as a mouse, trackball or touch pad. The microphone can cooperate with speech recognition software. These and other input devices are often connected to the processing unit through a user input interface that is coupled to the system bus, but can be connected by other interface and bus structures, such as a parallel port, game port, or a universal serial bus (USB). A display monitor or other type of display screen device is also connected to the system bus via an interface, such as a display interface. In addition to the monitor, computing devices may also include other peripheral output devices such as speakers, a vibrator, lights, and other output devices, which may be connected through an output peripheral interface.

The computing system can operate in a networked environment using logical connections to one or more remote computers/client devices, such as a remote computing system. The logical connections can include a personal area network (“PAN”) (e.g., Bluetooth©), a local area network (“LAN”) (e.g., Wi-Fi), and a wide area network (“WAN”) (e.g., cellular network), but may also include other networks. Such networking environments are commonplace in offices, enterprise-wide computer networks, intranets and the Internet. A browser application or direct app corresponding with a cloud platform may be resident on the computing device and stored in the memory.

It should be noted that the present design can be carried out on a single computing system and/or on a distributed system in which different portions of the present design are carried out on different parts of the distributed computing system.

Note, an application described herein includes but is not limited to software applications, mobile apps, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system. The systems and methods described herein can be implemented with these algorithms discussed herein.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry. The functionality performed by one or modules may be combined into a single module, where logically possible, and a modules functionality may be split into multiple modules.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A cyber threat defense system comprising:
a processing component; and
a non-transitory computer readable medium including one or more software modules accessible by the processing component, the one or more software modules comprising:
a vehicle module configured to receive data from a first vehicle and a second vehicle and reference one or more machine-learning models using machine-learning and artificial intelligence (AI) algorithms, the one or more machine-learning models including a first machine-learning model trained on a normal pattern of life associated with the first vehicle and the second vehicle, and
a comparator module configured to cooperate with the vehicle module to compare data received from the first vehicle and the second vehicle to the normal pattern of life associated with the first vehicle and the second vehicle to detect anomalies representing a cyber threat within the first vehicle or the second vehicle.

2. The cyber threat defense system of claim 1, wherein the one or more software modules further comprise:
a vehicle normal pattern of life module configured to update the first machine-learning model using unsupervised machine learning algorithms and feedback to routinely update the first machine-learning model of the normal pattern of life of the first vehicle and the second vehicle during operation of the first vehicle and the second vehicle.

3. The cyber threat defense system of claim 2, wherein the first machine-learning model is configured to model the normal pattern of life for the first vehicle and the second vehicle from data and/or meta data from protocols and data types of the first vehicle and the second vehicle.

4. The cyber threat defense system of claim 3, wherein the first machine-learning model is configured to use unsupervised machine learning algorithms and feedback on the data and/or the meta data from protocols and data types of the first vehicle and the second vehicle to routinely update the first machine-learning model of the normal pattern of life of the first vehicle and the second vehicle.

5. The cyber threat defense system of claim 1, wherein the first vehicle and the second vehicle are operated independently of one another.

6. The cyber threat defense system of claim 1, wherein the second vehicle is of a same or similar category to the first vehicle, wherein optionally the first category is a vehicle manufacturer or a vehicle model.

7. The cyber threat defense system of claim 1, wherein the vehicle module configured to receive data from a first probe installed within first vehicle and from a second probe installed within the second vehicle.

8. The cyber threat defense system of claim 7, comprising the first probe and the second probe, the first and second probes configured to provide data to the vehicle module over a network.

9. The cyber threat defense system of claim 7, wherein either the first probe is installed in an electronic control unit (ECU) of the first vehicle, or the second probe is installed in an ECU of the second vehicle, or both.

10. The cyber threat defense system of claim 9, wherein either the first probe is configured to monitor all network traffic inbound to and outbound from the first vehicle, or the second probe is configured to monitor all network traffic inbound to and outbound from the second vehicle, or both.

11. The cyber threat defense system of claim 9, wherein either the first probe, the second probe, or both are configured to receive data and/or the meta data from protocols and data types of their respective vehicle and perform one or more of:
i) translation, transformation, or both, on the data and/or the meta data into an acceptable format for the vehicle module before transmission over the network to the vehicle module;
ii) perform an initial analysis to filter the data and/or the meta data to reduce the amount of data and/or meta data transmitted compared to the amount of data and/or metadata received from the vehicle; and
iii) perform protocol parsing to retrieve desired data and/or meta data from the data and/or meta data from any of i) a data link layer, ii) a physical layer, or iii) both; and then, one or more of iv) an application layer, v) a transport layer, vi) a network layer, and vii) any combination of these three layers when that layer is used within the vehicle.

12. The cyber threat defense system of claim 1, wherein the one or more software modules further comprise:
an autonomous response module configured to determine an autonomous response to counter a detected cyber threat in the first vehicle or the second vehicle without human intervention.

13. The cyber threat defense system of claim 12, wherein the autonomous response module is configured to receive vehicle motion state information from the vehicle having the detected cyber threat and take the motion state information into account when determining the autonomous response.

14. The cyber threat defense system of claim 13, wherein the autonomous response is one or more of disabling a peripheral system of the vehicle that is not involved in the control of the motion of the first vehicle, displaying a graphical warning to a user of the vehicle, outputting an audible warning to a user of the vehicle, limiting the motion of the vehicle within certain parameters, preventing the vehicle from starting, and causing the vehicle to come to a controlled stop.

15. The cyber threat defense system of claim 1, wherein the one or more software modules further comprise:
an AI analyst module configured to analyze the anomalies detected by the comparator module to identify and/or classify anomalies as cyber threats utilizing a second machine-learning model trained on data comprising previous or simulated cyber threats.

16. The cyber threat defense system of claim 1, wherein the one or more software modules further comprise:
an operational technology module configured to receive data on an operational technology network from one or more sources and reference one or more machine-learning models using machine-learning and artificial intelligence (AI) algorithms, the one or more machine-learning models including a third machine-learning model trained on a normal pattern of life associated with a first entity and a fourth machine-learning model trained on a normal pattern of life associated with a second entity;
wherein the comparator module is further configured to cooperate with the operational technology module to compare data received from the operational technology network to at least the normal pattern of life associated with the first entity or the normal pattern of life associated with the second entity to detect anomalies representing a cyber threat in the operational technology network.

17. The cyber threat defense system of claim 16, wherein the operational technology module is configured to receive data from the one or more sources including i) a set of operational technology probes and ii) a network in which the data is traffic propagating over the operational technology network.

18. The cyber threat defense system of claim 16, wherein the normal pattern of life associated with the first entity comprises a normal pattern of life of devices in the operational technology network.

19. The cyber threat defense system of claim 16, wherein the normal pattern of life associated with the first entity comprises a normal pattern of life of controllers in the operational technology network.

20. The cyber threat defense system of claim 16, wherein the operational technology network is a factory network associated with a factory configured to manufacture at least one component of the first vehicle.

21. The cyber threat defense system of claim 1, wherein the one or more software modules further comprise:
an enterprise module configured to receive data on an enterprise network from one or more sources and reference one or more machine-learning models using machine-learning and artificial intelligence (AI) algorithms, the one or more machine-learning models including a fifth machine-learning model trained on a normal pattern of life associated with a third entity;
wherein the comparator module is further configured to cooperate with the enterprise module to compare data received from the enterprise network to at least the normal pattern of life associated with the third entity to detect anomalies representing a cyber threat in the enterprise network.

22. The cyber threat defense system of claim 21, wherein the enterprise network is a network associated with either or both of an organization involved in the design of at least one component of the first vehicle and an organization involved in providing at least one update to the first vehicle.

23. The cyber threat defense system of claim 1, wherein the first vehicle and the second vehicle are cars, motorbikes, or trucks.

24. The cyber threat defense system of claim 1, wherein the first vehicle and the second vehicle are connected vehicles.

25. The cyber threat defense system of claim 1, wherein the first vehicle and the second vehicle are autonomous vehicles.

26. A method for detecting a cyber threat by a cyber threat defense system, the method comprising:
receiving data from a first vehicle;
receiving data from a second vehicle;
referencing one or more machine-learning models using machine-learning and artificial intelligence (AI) algorithms, the one or more machine-learning models including a first machine-learning model trained on a normal pattern of life associated with the first vehicle and the second vehicle; and
comparing data received from the first vehicle and the second vehicle to the normal pattern of life associated with the first vehicle and the second vehicle to detect anomalies representing a cyber threat within the first vehicle or the second vehicle.

27. A non-transitory computer readable medium including one or more software modules to be executed by a processor, the one or more software modules comprising:
a vehicle module configured to receive data from a first vehicle and a second vehicle and reference one or more machine-learning models using machine-learning and artificial intelligence (AI) algorithms, the one or more machine-learning models including a first machine-learning model trained on a normal pattern of life associated with the first vehicle and the second vehicle, and
a comparator module configured to cooperate with the vehicle module to compare data received from the first vehicle and the second vehicle to the normal pattern of life associated with the first vehicle and the second vehicle to detect anomalies representing a cyber threat within the first vehicle or the second vehicle.
